(19) United States
(12) Patent Application Publication
(10) Pub. No.: US 2024/0406670 A1
(43) Pub. Date: Dec. 5, 2024

(54) NETWORK BASED GEO-FENCING IN WIRELESS NETWORKS

(71) Applicant: Verizon Patent and Licensing Inc., Basking Ridge, NJ (US)

(72) Inventors: Ye Huang, San Ramon, CA (US); Miguel A. Carames, Long Valley, NJ (US); Suzann Hua, Beverly Hills, CA (US); Tony Ferreira, Fairfield, CT (US); Alexander Fadeev, Summit, NJ (US)

(21) Appl. No.: 18/328,849

(22) Filed: Jun. 5, 2023

(51) Int. Cl. H04W 4/021; H04W 4/029

(52) U.S. Cl. CPC H04W 4/021; H04W 4/029

(57) ABSTRACT

A geo-fencing system stores a geo-fence associated with a geographic location of a user equipment device (UE). The geo-fencing system receives, from a Network Exposure Function (NEF) or Service Capability Exposure Function (SCEF) in a mobile network, a monitoring event (MONTE) location report associated with a current location of the UE within the mobile network, and extracts a Radio Access Network (RAN) location from the MONTE location report, where the RAN location identifies a cell, cell sector, eNodeB (eNB), gNodeB (gNB), or tracking area (TA) associated with the current location of the UE. The geo-fencing system determines, based on a comparison of the identified cell, cell sector, eNB, gNB, or TA with the stored geo-fence, whether the UE has entered or exited the geo-fence, and sends, based on the determination, a geo-fence alert to the NEF or SCEF for forwarding to a geo-fencing enabled application.

### BACKGROUND

Edge computing may involve a cloud-based Information Technology (IT) service environment located at an edge of a network. One of the purposes of edge computing is to enable high-bandwidth, low-latency access by deploying latency-sensitive applications at the edge of the network closer to an end user. Another goal of edge computing is to reduce network congestion and improve application performance by optimizing the location where task processing is performed, thereby improving the delivery of content and application services to the end users and reducing transport costs for high bandwidth services. Applications where edge computing is highly desirable may involve areas related to on-line gaming, augmented reality (AR), virtual reality (VR), wirelessly connected vehicles, and Internet of Things (IoT) applications (e.g., industry 4.0 applications). Additionally, edge computing can be beneficial in large public venues and enterprise organizations where services are delivered to onsite consumers from an edge server located at or near the venue or enterprise premises. In such large-scale use cases, content may be locally produced, stored, processed, and/or delivered from an edge server, thus, ensuring reduced backhaul, low latency, or even ultra-low latency.

### BRIEF DESCRIPTION OF THE DRAWINGS

FIG. 1 depicts an example of a network environment in which network-based geo-fencing is implemented that provides geo-fencing capabilities at a cell, evolved NodeB/Next Generation NodeB, and/or mobile network tracking area level;

FIG. 2 is a diagram that depicts exemplary components of a network device;

FIG. 3 is a diagram that depicts an example implementation of a geo-fence database;

FIGS. 4A and 4B are diagrams that illustrate examples of cells, Next Generation NodeBs/evolved NodeBs, and tracking areas associated with established geo-fences in a mobile network;

FIG. 5 is a flow diagram that illustrates an example process for subscribing to mobile network-based geo-fencing;

FIG. 6 is an example operations/messaging diagram associated with the process of FIG. 5;

FIG. 7 is a flow diagram that illustrates an example process for sending a geo-fence alert message to a geo-fencing enabled application when a user equipment device enters or exits an established geo-fence for that user equipment device; and

FIG. 8 is an example operations/messaging diagram associated with the process of FIG. 7.

### DETAILED DESCRIPTION OF EXAMPLE EMBODIMENTS

The following detailed description refers to the accompanying drawings. The same reference numbers in different drawings may identify the same or similar elements. The following detailed description does not limit the invention, which is defined by the claims.

Multi-Access Edge Computing (MEC) is one type of edge computing. MEC may move the processing, storing, and/or delivery of traffic and services from a centralized network (e.g., a mobile core network) to a data center(s) or server(s) residing at an edge location (e.g., an edge network) connected to the edge of the centralized network, closer to the end user. A MEC platform is typically deployed at the edge location, and one or more applications are installed upon the MEC platform. The MEC platform may, for example, include at least one MEC data center and may connect to a Local Access Data Network (LADN) that further connects to the edge network. MEC platforms may be connected to cloud Radio Access Networks (C-RANs), far edge networks, and/or edge networks such that data transport associated with sessions involving the different MEC platforms have different associated latencies.

New applications used in various networked environments, such as, for example, MECs, telematics, and Fixed Wireless Access (FWA), often require geo-fencing capabilities for the provision of services related to wireless User Equipment devices (UEs). The geo-fencing capabilities may include notifying an application(s) when a particular UE enters a pre-defined geographic area, or when the particular UE exits a pre-defined geographic area. For example, in the case of MECs, a particular MEC that hosts an application may be selected for handling a UE's traffic when a particular UE enters a pre-defined geographic area. In this case, as the UE enters the pre-defined geographic area, an MEC that is geographically closest to that geographic area may be selected to minimize latency in network communications to/from the UE. As another example, in the case of telematics, when a UE associated with a moving vehicle enters a pre-defined geographic area, a particular telematics server, or a particular MEC, that hosts a telematics application and that is closest to the pre-defined geographic area may be selected to also minimize latency in communications between the telematics application and the UE. In this case, the UE contained within the vehicle reports telematics data to the selected telematics application.

These new applications that require geo-fencing capabilities, however, may only need coarse level geo-fencing capabilities, such as, for example, at a cell/cell sector, an evolved NodeB (eNB)/Next Generation NodeB (gNB), or a tracking area level within the mobile network that supplies wireless connectivity to the UEs. The new applications may, thus, not require more accurate geo-location determination such as that provided using the Global Positioning System (GPS). Various techniques exist that enable the determination of UE location, typically, use a fine level location accuracy, such as, for example, that provided by GPS. Location based servers that are GPS-based are intended for fine grain accuracy and are resource intensive and have a high cost. UE client-based location determination requires a location service client or app to be installed at the UE and is not easily deployed at a large scale and is not client application agnostic. Third party geo-fencing servers that are connected to the mobile network are typically not easily integrated into service deployment in conjunction with the operation of a mobile network.

Example embodiments described herein implement a coarse level geo-fencing service that may be easily deployed without major modifications to the mobile network. The coarse level geo-fencing service described herein uses Monitoring Event (MONTE) location reports to supply UE geo-locations at a coarse level in the mobile network, such as at the cell, cell sector, eNB, gNB, or tracking area (TA) level. A geo-fencing system within the mobile network may use MONTE location reports, generated by an Access and Mobility Function (AMF) or Mobility Management Entity (MME) of the mobile network for a particular UE, to determine whether the UE has entered or exited one or more geo-fences. The one or more geo-fences may have previously been established based on geo-fence subscription requests from one or more geo-fencing enabled applications (e.g., hosted at a MEC).

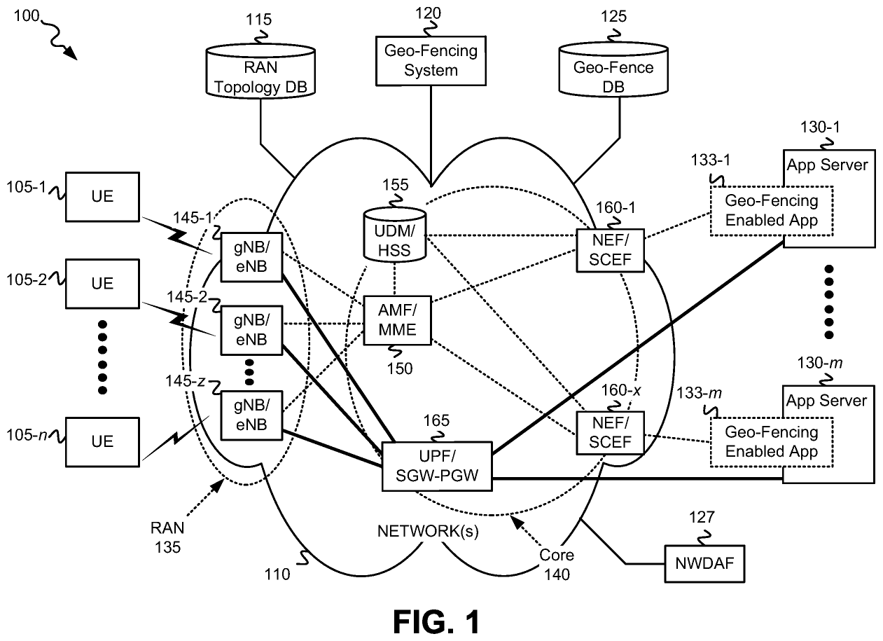

FIG. 1 depicts an example of a network environment 100 in which network-based geo-fencing is implemented that provides geo-fencing capabilities at a cell, eNB/gNB, and/or mobile network tracking area level. “Geo-fencing,” as referred to herein, may include determining when a particular UE enters a pre-defined geographic area within a mobile network, or when the particular UE exits a pre-defined geographic area within the mobile network. As shown, network environment 100 may include multiple UEs 105-1 through 105-n (where n is equal to or greater than one), a mobile network 110, a RAN topology DB 115, a geo-fencing system 120, a geo-fence database (DB) 125, a Network Data Analytics Function (NWDAF) 127, and one or more application (app) servers 130-1 through 130-m.

UEs 105-1 through 105-n (referred to herein individually as “UE 105” or collectively as “UEs 105”) may each include any type of electronic device that includes a wireless communication interface for communicating with network 110 via a wireless connection. UEs 105 may each include, for example, a cellular telephone; a “smart” phone; a personal digital assistant (PDA); a wearable computer; a Machine-to-Machine (M2M) device; an “Internet of Things” (IoT) device; a desktop, laptop, palmtop or tablet computer; or a media player. A respective subscriber (not shown) may be associated with one or more of UEs 105, where the subscriber may be an owner, operator, administrator, and/or a permanent or temporary user of the one or more UEs 105.

Mobile network 110 includes one or more wireless networks, and possibly one or more other types of networks of various types. The one or more wireless networks may each include, for example, a wireless Public Land Mobile Network (PLMN) or a wireless satellite network that is operated and/or administered by a particular wireless network service provider (a “carrier”). The PLMN may include a Long-Term Evolution (LTE) PLMN, a Next Generation (e.g., Fifth Generation) PLMN, and/or other types of PLMNs not specifically described herein. The one or more other types of networks of various types may include, for example, a telecommunications network (e.g., Public Switched Telephone Networks (PSTNs)), a wired and/or wireless local area network (LAN), a wired and/or wireless wide area network (WAN), a metropolitan area network (MAN), an intranet, the Internet, an Internet Protocol (IP) Multimedia Subsystem (IMS) network, and/or a cable network (e.g., an optical cable network). Though not shown in FIG. 1, mobile network 110 may connect to the one or more other types of networks.

Mobile network 110 may further include sub-networks, such as, for example, a Radio Access Network (RAN) 135 and a core network 140. RAN 135 may include various types of radio access equipment that enable radio frequency (RF) communication with UEs 105, and possibly other types of devices. If mobile network 110 includes Fourth Generation (4G) network components, the radio access equipment of RAN 135 may include eNBs. If mobile network 110 includes Fifth Generation (5G) network components (e.g., 5G Stand Alone (SA) or 5G Non-Stand Alone (NSA) components), the radio access equipment of RAN 135 may include gNBs. FIG. 1 shows RAN 135 as alternatively including either gNBs or eNBs, identified as gNB/eNB 145-1 through 145-z (where z is any integer greater than or equal to one).

Each of eNBs/gNBs 145 (also referred to herein as “base stations”) includes hardware that wirelessly communicates directly with wireless devices (e.g., UEs 105) to enable network service with mobile network 110 (e.g., a PLMN). For example, each of eNBs/gNBs 145 includes a wireless transceiver for communicating with the wireless devices, and a wired or wireless link for connecting to other nodes of the mobile network 110 such as, for example, wired links to one or more of the various network functions (NFs) of core network 140 of mobile network 110.

Core network 140 includes devices or nodes that host and execute NFs that operate the mobile network 110 including, among other NFs, mobile network access management, session management, and policy control NFs. In the example network environment 100 of FIG. 1, core network 140 is shown as including 4G or 5G mobile network components. In the case of a 5G mobile network, core network 140 may include an Access and Mobility Management Function (AMF) 150, a Unified Data Management (UDM) function 155, one or more Network Exposure Functions (NEFs) 160-1 through 160-x, and a User Plane Function (UPF) 165. In the case of a 4G mobile network, core network 140 may include a Mobility Management Entity (MME) 150, a Home Subscriber Server (HSS) 155, one or more Service Capability Exposure Functions (SCEFs) 160-1 through 160-x, and a Serving Gateway/Packet data network Gateway (SGW/PGW) 165. The NFs shown in FIG. 1 may be hosted and executed by one or more network devices within mobile network 110. Multiple NFs may be hosted and executed by a single network device, and the various NFs of FIG. 1 may be distributed across multiple network devices.

AMF 150 performs authentication, authorization, and mobility management for UEs 105. UDM function 155 manages data for user access authorization, user registration, and data network profiles. UDM 155 may include, or operate in conjunction with, a Unified Data Repository (UDR—not shown) which stores user data, such as customer profile information, customer authentication information, user-subscribed network slice information, and encryption keys.

NEFs 160-1 through 160-x (referred to herein individually as “NEF 160” or collectively as “NEFs 160”) each provide an interface to securely expose the services and capabilities provided by the NFs of mobile network 110 to, for example, external entities (e.g., app servers 130). UPF 165 may act as a router and a gateway between mobile network 110 and an external data network (e.g., the Internet, not shown), and forwards session data between the external data network and RAN 135. Though only a single UPF 165 is shown in FIG. 1, mobile network 110 may include multiple UPFs 165 at various locations in network 110.

MME 150 performs, within mobile network 110, mobility management functions, call control management functions, session management functions, and/or identity management functions associated with providing wireless service to UEs 105. HSS 155 stores and maintains subscriber profiles, and may perform, based on the information stored in the data structure, a user authentication function, a session establishment function, and/or an access authorization function.

SCEFs 160-1 through 160-x (referred to herein individually as “SCEF 160” or collectively as “SCEFs 160”) each provide an interface for the secure delivery of mobile network services to external entities (e.g., app servers 130). SCEFs 160 may act as gateways between apps executed by app servers 130 and UEs 105 over mobile network 110. SCEFs 160 may, in some implementations, deliver network service-related data via, for example, non-Internet Protocol (IP) data delivery. SGW-PGW 165 includes a SGW and a PGW. The SGW includes one or more network devices that route and forward data packets received from UEs 105 and destined for nodes in an external network; and also route and forward data packets received from the PGW destined for one or more UEs 105. The PGW includes one or more network devices that provide connectivity from the UEs 105 to other networks connected to wireless network 205, such as other external networks (e.g., the Internet). Though shown in FIG. 1 as a single component, the SGW and PGW may include separate components, that are in different locations, within mobile network 110.

RAN topology DB 115 includes at least one network device that stores a data structure containing data describing the topology of RAN 135. The topology data may relate geographic location data (e.g., geographical coordinates) to the locations of eNBs/gNBs 145, the locations of cells or cell sectors, and the locations of tracking areas (TAs), within RAN 135.

Geo-fencing system 120 includes at least one network device that performs a number of functions related to providing geo-fencing services within mobile network 110. The functions may include receiving designated geographic areas in geographic coordinates, such as latitude/longitude coordinates, and consulting RAN topology DB 115 to translate the geographic coordinates to TAs, eNBs/gNBs, and/or cells/cell sectors within RAN 135. The functions may further include creating geo-fence contexts, that each include, for example, a UE identifier (ID), a UE group ID, a geo-fence ID, a geo-fence geographic area, and the TAs, eNBs/gNBs, and/or cells/cell sectors translated from the geographic area, and storing the geo-fence contexts within geo-fence DB 125. The functions may also include comparing the content of MONTE location reports with the TAs, eNBs/gNBs, and/or cells/cell sectors stored in the geo-fence contexts for active geo-fences to create geo-fence alerts that indicate that a particular UE 105 has entered or exited a particular geo-fence.

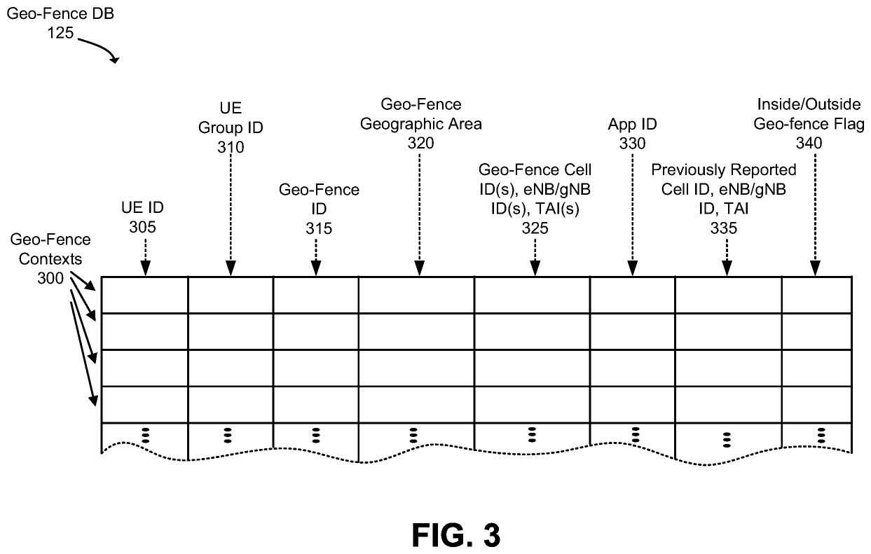

Geo-fence DB 125 includes at least one network device that stores a data structure, such as described below with respect to FIG. 3, that stores geo-fence contexts associated with a particular UE 105 or a particular group of UEs 105. Each geo-fence context may include, for example, a UE identifier (ID), a UE group ID, a geo-fence ID, a geo-fence geographic area, and the TAs, eNBs/gNBs, and/or cells/cell sectors of RAN 135 translated from the geo-fence geographic area.

NWDAF 127 may collect and/or generate analytics information associated with mobile network 110 and/or RAN 135. For example, NWDAF 127 may receive Key Performance Indicators (KPIs) associated with traffic in network environment 100 from elements/network functions in network environment 100. In some implementations, NWDAF 127 may receive location information associated with UEs 105 and/or geo-fencing information associated with UEs 105 from gNGs/eNBs 145, AMF/MME 150, and/or other elements in network environment 100.

App servers 130-1 through 130-m (referred to herein individually as “app server 130” or collectively as “app servers 130”) may include network devices that store and execute various different apps that provide services to, or for, UEs 105 and may otherwise communicate with UEs 105. As shown, each app server 130 may host and execute one or more geo-fencing enabled apps (shown as geo-fencing enabled app 133-1 through 133-m). Each of the geo-fencing enabled apps 133 request a geo-fencing service from mobile network 110 to enable the apps 133 to provide their own network services to, or to otherwise communicate with, UEs 105. Though each app server 133 is shown as hosting a single geo-fencing enabled app 133, each app server 130 may host and execute multiple apps 133. App servers 130 may communicate with UEs 105 either via a control plane of mobile network 110 (e.g., via a NEF/SCEF 160), or via a user plane of mobile network 110 (e.g., via UPF/SGW-PGW 165). App servers 130 may connect directly to mobile network 110, or may connect indirectly to mobile network 110 via one or more intervening networks (not shown), such as, for example, edge or far edge networks connected to mobile network 110, or other types of networks (e.g., the Internet) connected to mobile network 110. In some implementations, app servers 130 may include MEC platforms that host one or more of the geo-fencing enabled applications 133 and that may be located at particular geographic locations.

The configuration of the components of network environment 100 depicted in FIG. 1 is for illustrative purposes only, and other configurations may be implemented. Therefore, network environment 100 may include additional, fewer and/or different components, that may be configured differently, than depicted in FIG. 1. For example, though a single UPF/SGW-PGW 165 is shown in core network 140, core network 140 may include multiple UPF/SGW-PGW 165 that are located at different locations within mobile network 110.

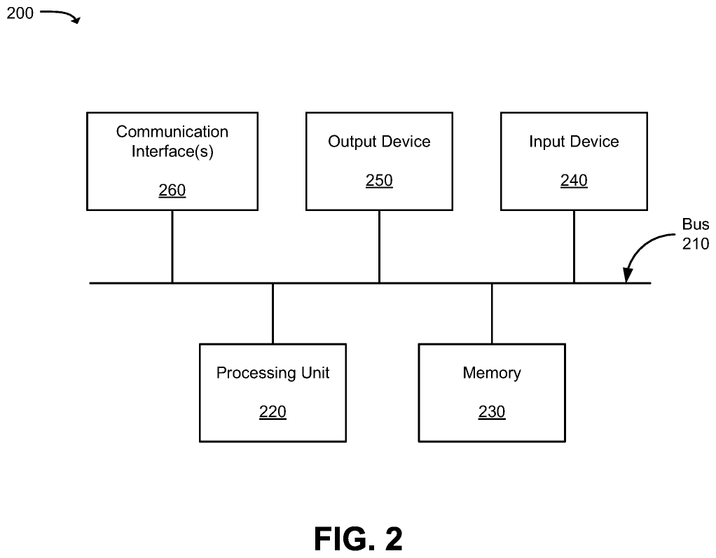

FIG. 2 is a diagram that depicts exemplary components of a network device 200 (referred to herein as a “network device 200” or “device 200”). UEs 105, gNBs/eNBs 145, RAN topology DB 115, geo-fencing system 120, geo-fence DB 125, and app servers 130 may each include a device or devices similar to network device 200, possibly with some variations in components and/or configuration. Additionally, the various NFs of mobile network 110 (e.g., UDM/HSS 155, AMF/MME 150, NEF/SCEF 160, UPF/SGW-PGW 165) may be implemented by a network device that includes one or more components that are the same as, or similar to, those of device 200. Some of the NFs may be implemented by a same device 200 within mobile network 110, while others of the functions may be implemented by one or more separate devices 200 within mobile network 110 that may be interconnected by network links. Device 200 may include a bus 210, a processing unit 220, a memory 230, an input device(s) 240, an output device(s) 250, and a communication interface(s) 260.

Bus 210 may include a path that permits communication among the components of device 200. Processing unit 220 may include one or more processors or microprocessors which may interpret and execute instructions, or processing logic. Memory 230 may include one or more memory devices for storing data and instructions. Memory 230 may include a random access memory (RAM) or another type of dynamic storage device that may store information and instructions for execution by processing unit 220, a Read Only Memory (ROM) device or another type of static storage device that may store static information and instructions for use by processing unit 220, and/or a magnetic, optical, or flash memory recording and storage medium. The memory devices of memory 230 may each be referred to herein as a “tangible non-transitory computer-readable medium,” “non-transitory computer-readable medium,” or “non-transitory storage medium.” In some implementations, the blocks of the processes/methods set forth herein can be implemented as instructions that are stored in memory 230 for execution by processing unit 220.

Input device 240 may include one or more mechanisms that permit an operator to input information into device 200, such as, for example, a keypad or a keyboard, a display with a touch sensitive panel, voice recognition and/or biometric mechanisms, etc. Output device 250 may include one or more mechanisms that output information to the operator, including a display, a speaker, etc. Input device 240 and output device 250 may, in some implementations, be implemented as a user interface (UI) (e.g., a graphical UI) that displays UI information and which receives user input via the UI.

Communication interface 260 may include a transceiver(s) that enables device 200 to communicate with other devices and/or systems. For example, communication interface 260 may include one or more wired and/or wireless transceivers for communicating via mobile network 110. In the case of eNBs/gNBs 145 of RAN 135, communication interface 260 may further include one or more antenna arrays for producing radio frequency (RF) cells or cell sectors for UE 105 access.

The configuration of components of network device 200 shown in FIG. 2 is for illustrative purposes. Other configurations may be implemented. Therefore, network device 200 may include additional, fewer and/or different components, arranged in a different configuration, than depicted in FIG. 2. For example, an Internet of Things (IoT) UE 105 may include similar components to those shown in FIG. 3, but may omit input device 240 and output device 250.

FIG. 3 is a diagram that depicts an example implementation of geo-fence DB 125. As shown, a data structure of geo-fence 125 may include multiple geo-fence contexts 300, with each context 300 including a UE identifier (ID) field 305, a UE group ID field 310, a geo-fence ID field 315, a geo-fence geographic area field 320, a geo-fence cell ID(s), eNB/gNB ID(s), and/or Tracking Area Identifiers (TAIs) field 325, an app ID field 330, a previously reported cell ID, eNB/gNB ID, and/or Tracking Area Identifier (TAI) field 335, and an inside/outside geo-fence flag field 340. The data structure of geo-fence DB 125 may be stored within memory 230 of a network device 200.

UE ID field 305 stores a unique ID (e.g., a globally unique identifier (GUID)) associated with a particular UE 105. The UE ID may include, for example, an International Mobile Subscriber Identity (IMSI), Mobile Directory Number (MDN), and/or a network address associated with the particular UE 105. UE group ID field 310 stores a unique ID associated with a group of UEs 105. For example, a single subscriber may own and/or operate multiple UEs 105, and may assign a UE group ID to the group of UEs 105.

Geo-fence ID field 315 stores a unique ID for a geo-fence that is represented in DB 125 by the data values of context 300 stored in fields 305-325. Geo-fence geographic area field 320 stores geographic coordinates (e.g., GPS coordinates) of a pre-defined geographic area. A geo-fencing enabled app 133 may supply, via NEF/SCEF 160, the geographic coordinates of the pre-defined geographic area to geo-fencing system 120 for creating the geo-fence.

Geo-fence cell ID(s), eNB/gNB ID(s), and/or TAIs field 325 stores IDs of cells, cell sectors, eNBs, gNBs, or TAs that are associated with the pre-defined geographic area stored in field 320. For example, geo-fencing system 120 may translate the geographic coordinates of the pre-defined geographic area (e.g., stored in field 320), using RAN topology mapping data stored in RAN topology DB 115, into cell IDs, cell sector IDs, eNB IDs, gNB IDs, or TAIs that are contained within the pre-defined geographic area. The cell ID(s), cell sector ID(s), eNB/gNB(s), and/or TAIs stored in field 325, therefore, represent the pre-defined geographic area of the geo-fence at a cell, eNB/gNB, and/or TA level.

App ID field 330 may store one or more unique application IDs associated with the geo-fencing enabled app(s) 133 for which the geo-fence of the context 300 is established. The one or more unique application IDs may include, for example, a unique ID for the app 133 and/or a network address (e.g., an Internet Protocol (IP) address) for the app server 130 that hosts the particular app 133.

Previously reported cell ID, eNB/gNB ID, and/or TAI field 335 may store RAN location data obtained from a previous MONTE location report reported for the UE 105 identified in field 305. The RAN location data may include a cell/cell sector ID, an eNB ID, a gNB ID, and/or a TAI associated with the previous location of the UE 105, such as previously reported prior to a most recent UE MONTE location report. As described below, the RAN location data stored in field 335 may be compared with a currently reported RAN location, and with the geo-fence data stored in field 325, to determine whether the UE 105 has entered or exited the geo-fence.

Inside/outside geo-fence flag field 340 may store a flag value indicating whether the UE 105 was previously determined to be inside or outside of the geo-fence identified in field 325 of the context 300. For example, a single bit may be set (bit=high or “1”) to indicate that the UE 105 was previously determined to be inside the geo-fence, and the single bit may be reset (bit=low or “0”) to indicate that the UE 105 was previously determined to be outside the geo-fence. As described below, the flag value stored in field 340 may be used in determining whether a UE 105 has entered or exited a geo-fence between two successive UE MONTE location reports received by geo-fencing system 120.

To locate a particular geo-fence context 300 in geo-fence DB 125, DB 125 may be queried with, for example, a UE ID to locate a context(s) 300 having a matching UE ID stored in field(s) 305. When such a context 300 is located, data may be stored in one or more fields 305, 310, 315, 320, 325, and/or 330, or data may be retrieved from one or more fields 305, 310, 315, 320, 325, and/or 330. Other fields of a context 300, instead of UE ID field 305 or in addition to UE ID field 305, may alternatively be used for querying geo-fence DB 125.

Geo-fence DB 125 is depicted in FIG. 3 as including a tabular data structure having a certain number of fields having certain content. The tabular data structure of geo-fence DB 125 shown in FIG. 3, however, is for illustrative purposes. Other types of data structures may alternatively be used. The number, types, and content of the contexts and/or fields in the data structure of geo-fence DB 125 illustrated in FIG. 3 is also for illustrative purposes. Other data structures having different numbers of, types of and/or content of, the contexts and/or the fields may be implemented. Therefore, geo-fence DB 125 may include additional, fewer and/or different entries and/or fields than those depicted in FIG. 3.

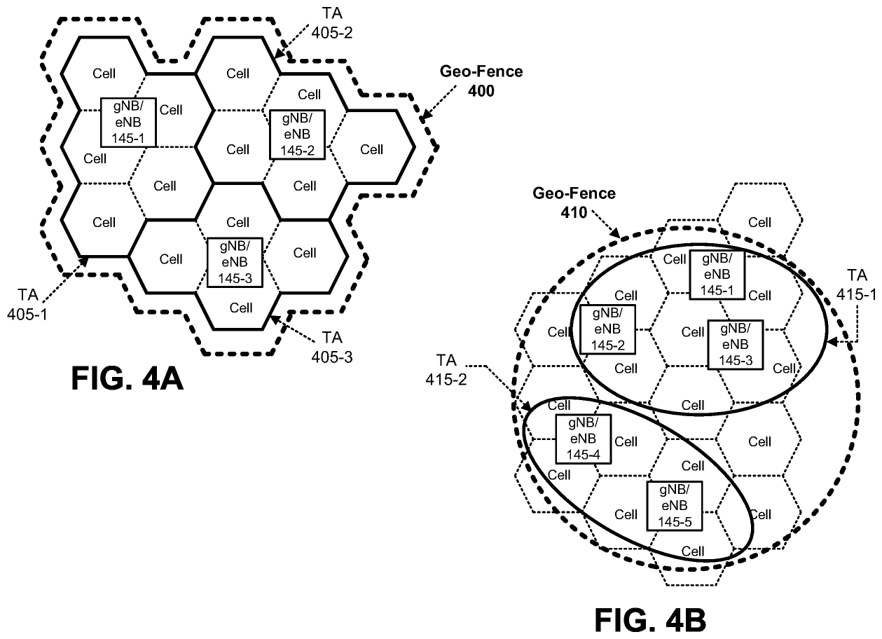

FIGS. 4A and 4B are diagrams that illustrate examples of cells, gNBs/eNBs, and TAs associated with established geo-fences in the mobile network. FIG. 4A depicts a first example of a geo-fence 400 established in a first portion of the mobile network. In the example of FIG. 4A, the TAs are composed of cells, with a first TA 405-1 including five contiguous cells, a second TA 405-2 including another five contiguous cells, and a third TA 405-3 including an additional four contiguous cells. The established geo-fence 400, as shown by the dotted line around the perimeter of the cells, includes TAs 405-1, 405-2, and 405-3.

FIG. 4B depicts a second example of a geo-fence 410 established in a second portion of the mobile network. In the example of FIG. 4B, the TAs are composed of gNBs/eNBs, with a first TA 415-1 including three gNBs/eNBs 145-1, 145-2, and 145-3. A second TA 415-2 includes two gNBs/eNBs 145-4 and 145-5. The established geo-fence 410, as shown by the dotted line around the perimeter of the gNBs/eNBs, includes TAs 415-1 and 415-2.

Though FIGS. 4A and 4B only depict cells within a mobile network, a given geo-fence 400 or 410 may additionally, or alternatively, include cell sectors.

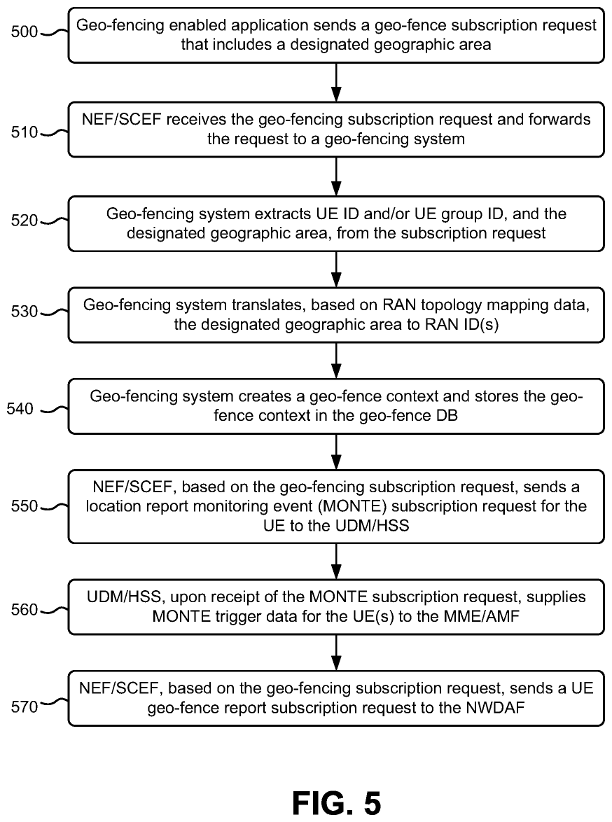

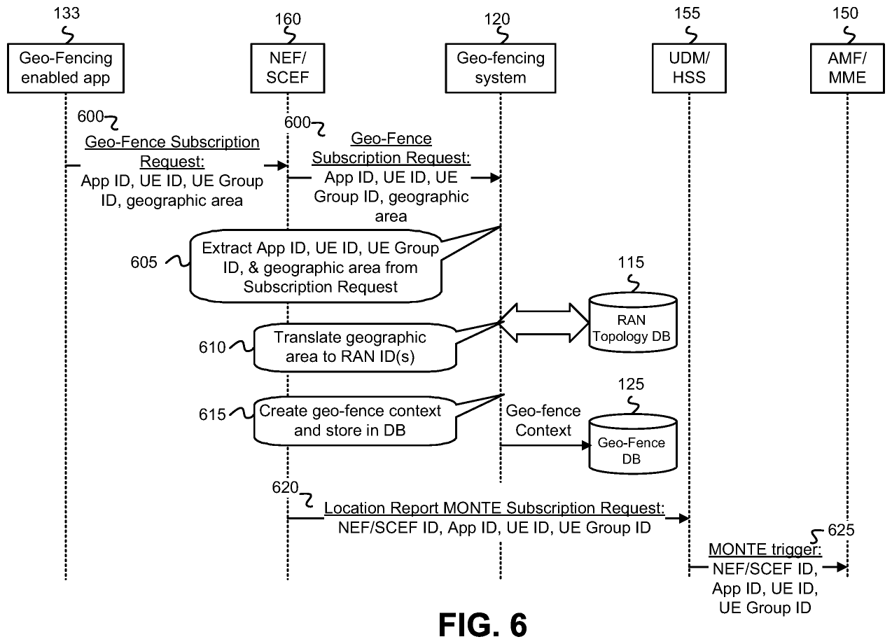

FIG. 5 is a flow diagram that illustrates an example process for subscribing to mobile network-based geo-fencing. The subscription process of FIG. 5 may be initiated by a geo-fencing enabled app 133 supplying, via a NEF/SCEF 160, a pre-defined geographic area associated with one or more particular UEs 105 to geo-fencing system 120 for creation of a geo-fence for the one or more UEs 105. In one implementation, the example process of FIG. 5 may be implemented by geo-fencing system 120, in conjunction with NEF/SCEF 160, UDM/HSS 155, and AMF/MME 150. The example process of FIG. 5 is described below with reference to the messaging/operations diagram of FIG. 6.

The example process includes a geo-fencing enabled application 133, executed by an app server 130, sending a geo-fence subscription request to mobile network 110 that includes a designated geographic area (block 500). The geo-fence subscription request may further include an app ID associated with the geo-fencing enabled app 133, and one or more UE IDs associated with at least one UE 105 to which a geo-fence is to be applied. The geo-fence subscription request may additionally include a UE group ID that identifies a group of UEs 105 to which the geo-fence is to be applied, and an ID(s) associated with the app 133, and/or the app server 130 that hosts the app 133, that originated the geo-fence subscription request. FIG. 6 shows geo-fencing enabled app 133 sending a geo-fence subscription request 600 to NEF/SCEF 160, where the request 160 may include an app ID, a UE ID, a UE group ID, and a pre-defined geographic area.

NEF/SCEF 160 receives the geo-fencing subscription request and forwards the request to geo-fencing system 120 (block 510). Prior to forwarding the subscription request to system 120, NEF/SCEF 160 may perform authentication and authorization of the geo-fencing enabled application 133 and/or the app server 130. Various different existing authentication techniques may be used by NEF/SCEF 160 for authenticating the app server 130 and/or the subscription request. If authentication or authorization fails, then NEF/SCEF 160 may not forward the subscription request to system 120, and also may not execute the remaining blocks of FIG. 5 (e.g., blocks 520-570). FIG. 6 depicts NEF/SCEF 160 then forwarding the request 600 to geo-fencing system 120.

Geo-fencing system 120 extracts an app ID, a UE ID, a UE group ID, and the designated geographic area, from the received subscription request (block 520), translates, based on RAN topology mapping data obtained from RAN topology DB 115, the designated geographic area to RAN IDs (block 530), and creates a geo-fence context and stores the geo-fence context in geo-fence DB 125 (block 540). Geo-fencing system 120 takes the geographic coordinates of the designated geographic area and identifies, using RAN topology mapping data stored in RAN topology DB 115, the cells, cell sectors, eNBs, gNBs, and/or tracking areas that are contained with the geographic coordinates of the designated geographic area. Further, using the RAN topology mapping data, geo-fencing system 120 determines the RAN IDs associated with the cells, cells sectors, eNBs, gNBs, and/or TAs contained within the designated geographic area. The RAN IDs may include, for example, cell IDs of each of the cells or cell sectors, eNB IDs associated with each of the eNBs, gNB IDs associated with each of the gNGs, and TAIs associated with each of the TAs contained within the designated geographic area. One or more RAN IDs (e.g., cell/cell sector ID, eNB/gNB ID, TAI) associated with a location of a UE 105 within RAN 135 may also be referred to herein as a “RAN location.” Geo-fencing system 120 generates a unique geo-fence ID for the geo-fence context (e.g., an alphanumeric ID), and then generates a list of RAN IDs for the geo-fence corresponding to the determined RAN IDs for the designated geographic area. Geo-fencing system 120 creates the geo-fence context as including the UE ID, UE group ID, geo-fence ID, geo-fence geographic area, the cell/cell sector IDs, eNB/gNB IDs, and/or TAIs, and app ID. Geo-fencing system 120 stores the data in a geo-fence context 300 of geo-fence DB 125.

FIG. 6 depicts geo-fencing system 120 extracting 605 the app ID, the UE ID, the UE group ID, and the pre-defined geographic area from the subscription request 600, and translating 610 the geographic coordinates of the pre-defined geographic area, using RAN topology mapping data stored in RAN topology DB 115, to one or more RAN IDs. FIG. 6 further shows geo-fencing system 120 creating 615 a geo-fence context and storing the geo-fence context in geo-fence DB 125.

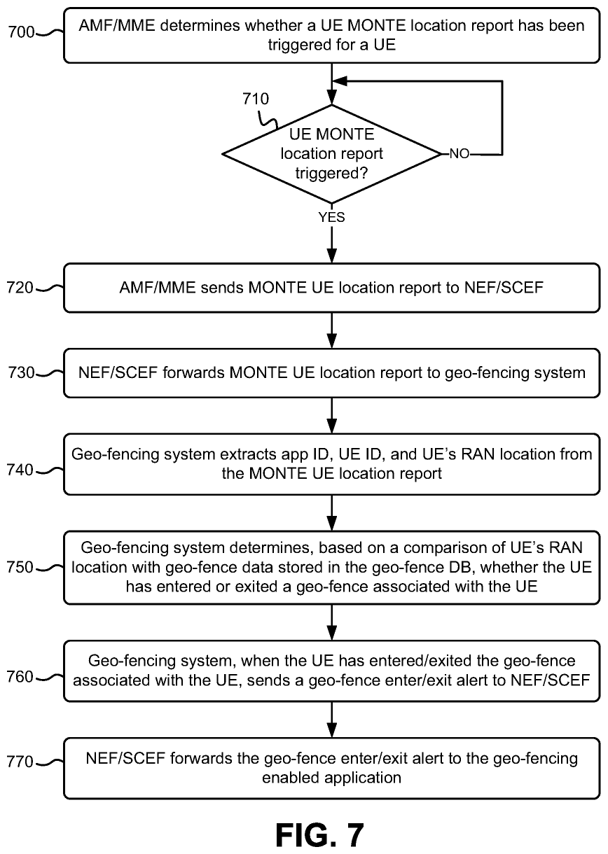

NEF/SCEF 160, based on the geo-fencing subscription request received in block 510, sends a location report monitoring event (MONTE) subscription request for the UE 105 to UDM/HSS 155 (block 550), and UDM/HSS 155, upon receipt of the MONTE subscription request, supplies MONTE trigger data for the UE(s) 105 to MME/AMF 150 (block 560). FIG. 6 shows NEF/SCEF 160, subsequent to receipt of the geo-fence subscription request 600, sending a location report MONTE subscription request 620 to UDM/HSS 155, where the subscription request 620 may include an app ID, a UE ID, and a UE group ID. FIG. 6 further depicts UDM/HSS 155 sending MONTE trigger data 625 to AMF/MME 150 to enable AMF/MME 150 to establish a MONTE trigger for the UE identified by the UE ID. The MONTE trigger data may include a NEF/SCEF ID for identifying NEF/SCEF 160 (i.e., that sent the location MONTE subscription request in block 550 and which is currently handling the relaying of data between mobile network 110 and the geo-fencing enabled app 133), an app ID associated with the geo-fencing enabled app 133 that sent the subscription request in block 500, the UE ID associated with the UE 105 and/or the UE group ID associated with a set of UEs 105 for which the app 133 has requested a geo-fencing subscription. Upon receipt of the MONTE trigger for the UE 105 or group of UEs 105, AMF/MME 150 installs the MONTE trigger for the UE(s) 105 and the app 133 such that, as described below with respect to blocks 700 and 710 of the example process of FIG. 7, when a location report is triggered by AMF/MME 150, AMF/MME 150 may return a MONTE UE location report to the NEF/SCEF 160 handling MONTE reports for a particular geo-fencing enabled app 133 at an app server 130. The MONTE trigger installed at AMF/MME 150 identifies the UE ID and/or UE group ID associated with the MONTE trigger, the app ID of the geo-fencing enabled app 133 which has subscribed to the MONTE location report, and identifies the NEF/SCEF ID (e.g., a network address of the NEF/SCEF 160) through which a MONTE location report is to be relayed when sending the report to the app 133.

NEF/SCEF 160, based on the geo-fencing subscription request received in block 510, sends a UE geo-fence report subscription request to NWDAF 127 (block 570). NWDAF 127 may include logic, such as an Application Programming Interface (API) associated with geo-fencing, to identify UEs 105 entering and/or exiting a geo-fence based on information provided by gNBs/eNBs/145, AMF/MME 150, and/or other elements/devices in network environment 100, such as NEF/SCEF 160. For example, as described above, NEF/SCEF 160 may send a request to subscribe to geo-fence reports provided by NWDAF 127. In such an implementation, when UEs 105 have entered or exited a geo-fence, and/or are approaching a boundary of a geo-fence, NWDAF 127 may provide alerts to NEF/SCEF 160 indicating that, for example, a particular UE 105 has entered or exited a geo-fence.

The example process of FIG. 5 may be repeated for each occurrence of a geo-fencing enabled application 133 subscribing to a geo-fencing service involving one or more UEs 105.

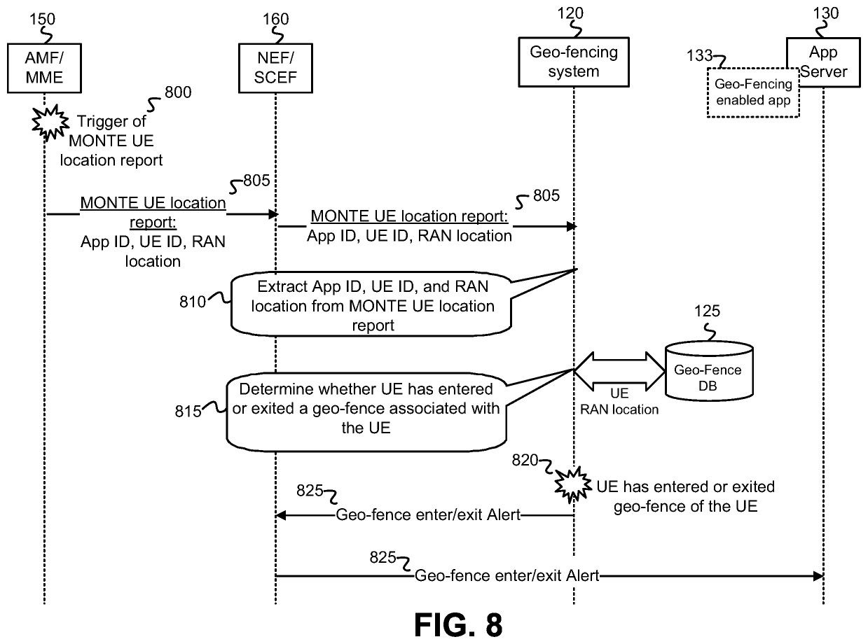

FIG. 7 is a flow diagram that illustrates an example process for sending a geo-fence alert message to a geo-fencing enabled application 133 when a UE 105 enters or exits an established geo-fence for that UE 105. The example process of FIG. 7 may occur subsequent to the network-based geo-fence subscribing process described above with respect to FIGS. 5 and 6 and, therefore, may be considered part of an overall process that includes execution of the process of FIG. 5 followed subsequently by execution of the process of FIG. 7. In some implementations, the example process of FIG. 7 may be implemented by geo-fencing system 120, in conjunction with AMF/MME 150, NEF/SCEF 160, and geo-fence DB 125. The example process of FIG. 7 is described below with reference to the exemplary messaging/operations diagram of FIG. 8.

AMF/MME 150 determines whether a UE MONTE location report has been triggered for a UE 105 (block 700) and, if a UE MONTE location report has been triggered (YES-block 710), then AMF/MME 150 sends a MONTE location report to NEF/SCEF 160 (block 720). The NEF/SCEF 160 further forwards the MONTE UE location report to the geo-fencing system 120 (block 730). Block 710 repeats if a UE MONTE location report has not been triggered (NO-block 710). A MONTE location report may be triggered for a particular UE 105 based on, for example, a periodic interval. Alternatively, or additionally, a MONTE location report for the UE 105 may be triggered upon the occurrence of an event associated with the UE 105. For example, the event may include the UE 105 travelling a specified distance; crossing from one cell/cell sector to another cell/cell sector; changing from receiving wireless service by a first eNB/gNB to a second eNB/gNB; or crossing from a first TA to a second TA. Other events associated with the UE 105 may, however, trigger the MONTE location report for the UE 105. AMF/MME 150, prior to sending the MONTE location, determines the NEF/SCEF ID and app ID associated with the MONTE trigger (e.g., previously received in block 560 of the example process of FIG. 5) and generates the UE MONTE location report by including the app ID, UE ID, and current RAN location in the body of the report, and inserting the NEF/SCEF ID (e.g., a network address of the NEF/SCEF 160) in the destination of the header of the MONTE location report. The current RAN location of the UE 105 may include an ID of a current cell or cell sector where the UE 105 is located, an ID of a current eNB or gNB that is serving the UE 105 at its current location, and/or a TAI of a current TA where the UE 105 is located. FIG. 8 shows the triggering 800 of a MONTE UE location report at AMF/MME 150 for a particular UE 105. FIG. 8 further shows AMF/MME 150 sending, based on the triggering 800, a MONTE UE location report 805 to NEF/SCEF 160, and NEF/SCEF 160 forwarding the MONTE UE location report 805 to geo-fencing system 120. As further shown in FIG. 8, the MONTE UE location report 805 may include an app ID, a UE ID, and a RAN location (e.g., cell/cell sector ID, eNB/gNB ID, TAI) associated with a current location of the UE 105 within RAN 135.

Geo-fencing system 120 extracts the app ID, UE ID, and the UE 105's RAN location from the MONTE UE location report (block 740), and determines, based on a comparison of the UE 105's current RAN location with geo-fence data stored in the geo-fence DB 125, whether the UE 105 has entered or exited a geo-fence associated with the UE 105 (block 750). Geo-fencing system 120 first identifies the previous RAN location of the UE 105, and whether a previous iteration of the process of FIG. 7 determined whether the UE 105 was inside, or outside, of any geo-fences stored in contexts 300 of geo-fence DB 125 having a UE ID that matches the UE 105's UE ID stored in a field 305 of the contexts 300. For example, geo-fencing system 120 may identify each context 300 in DB 125 having a UE ID stored in field 305 that matches the UE 105's UE ID. For each identified context, geo-fencing system 120 retrieves the contents of field 335, which identifies the previously reported cell ID(s), eNB/gNB ID(s), and/or TAI(s) for the UE 105 (e.g., reported in blocks 720 and 730 of a previous iteration of the example process of FIG. 7), and retrieves the contents of field 340, which identifies (e.g., flag=set=“inside,” or flag=reset=“outside”) whether the previously reported cell ID(s), eNB/gNB ID(s), and/or TAI(s) of the UE 105 was determined to be inside or outside the geo-fence stored in field 325 of the identified context 300.

For each of the contexts 300 of geo-fence DB 125 having a UE ID that matches the UE 105's UE ID stored in a field 305, geo-fence system 120 compares the currently reported RAN location of the UE 105 (e.g., reported in blocks 720 and 730 of the current iteration of the example process of FIG. 7) with the geo-fence cell ID(s), eNB/gNB ID(s), and/or TAI(s) of the geo-fence to determine whether the UE 105 is currently inside or outside of the geo-fence whose borders are defined in field 325. If the UE 105 is determined to be currently inside the geo-fence, geo-fencing system 120 determines if the contents of field 340 of the context 300 indicates that the UE 105 was previously inside or outside of the same geo-fence. If UE 105 was previously outside the geo-fence, then geo-fencing system 120 determines that the UE 105 has entered the geo-fence of the context 300, and generates a geo-fence enter alert, as described below with respect to block 760. If UE 105 was previously inside the geo-fence, and the UE 105 is determined to also currently be inside the geo-fence, then geo-fencing system 120 does not generate an enter/exit alert since the UE 105 has stayed within the boundaries of the geo-fence. If the UE 105 is determined to be currently outside the geo-fence, geo-fencing system 120 determines if the contents of field 340 of the context 300 indicates that the UE 105 was previously inside or outside of the geo-fence. If UE 105 was previously outside the geo-fence, then geo-fencing system 120 determines that the UE 105 has not entered or exited the geo-fence, and no geo-fence alert is generated. If UE 105 was determined previously to be inside the geo-fence, then geo-fencing system 120 determines that the UE 105 has exited the geo-fence of the context 300, and generates a geo-fence exit alert, as described below with respect to block 760. FIG. 8 shows geo-fencing system 120 determining 815, based on a comparison of the UE 105's current RAN location with geo-fencing data stored in geo-fence DB 125, whether the UE 105 has entered or exited any of the geo-fences associated with the UE 105.

Geo-fencing system 120, when the UE 105 has entered or exited the geo-fence associated with the UE 105, sends a geo-fence enter/exit alert to NEF/SCEF 160 (block 760), and NEF/SCEF 160 forwards the geo-fence enter/exit alert to the geo-fencing enabled application (block 770). Additionally, subsequent to block 750, geo-fencing system 120 stores the UE 105's current RAN location in field 335 of each context 300 having a UE ID stored in field 305 that matches the UE 105's UE ID. Geo-fencing system 120 further stores a value in field 340 for each of the context 300s that indicates whether the current location of UE 105 is inside or outside the geo-fence identified in field 325 of each context 300 having a UE ID stored in field 305 that matches the UE 105's UE ID. The newly stored contents of fields 335 and 340 may be used in subsequent iterations of the example process of FIG. 7 to determine whether the UE 105 has entered or exited a geo-fence stored in DB 125. FIG. 8 depicts geo-fencing system 120 determining 820 that the UE 105 has entered or exited a geo-fence of the UE 105, and then sending a geo-fence enter/exit alert 825 to NEF/SCEF 160. FIG. 8 further shows NEF/SCEF forwarding the geo-fence enter/exit alert 825 to geo-fencing enabled app 133 hosted by an app server 130.

The example process of FIG. 7 may be repeated, for each UE 105 that is associated with a geo-fencing subscription, either periodically (e.g., every 15 seconds), or upon the occurrence of a particular event associated with the UE 105. The particular triggering event for executing the process of FIG. 7 may include, for example, the UE 105 travelling a specified distance; crossing from one cell/cell sector to another cell/cell sector; changing from receiving wireless service by a first eNB or gNB to a second eNB or gNB; and/or crossing from a first TA to a second TA.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 5 and 7, and messages/operations flows with respect to FIGS. 6 and 8, the order of the blocks and/or the message/operations flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 220) of a device. A non-transitory storage medium includes one or more of the storage mediums described in relation to memory 230. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
storing, by a geo-fencing system, a geo-fence associated with a geographic location of a user equipment device (UE);
receiving, by the geo-fencing system from a Network Exposure Function (NEF) or Service Capability Exposure Function (SCEF) in a mobile network, a monitoring event (MONTE) location report associated with a current location of the UE within the mobile network;
extracting, by the geo-fencing system, a Radio Access Network (RAN) location from the MONTE location report, wherein the RAN location identifies a cell, cell sector, eNodeB (eNB), gNodeB (gNB), or tracking area (TA) associated with the current location of the UE;
determining, by the geo-fencing system based on a comparison of the identified cell, cell sector, eNB, gNB, or TA with the stored geo-fence, whether the UE has entered or exited the geo-fence; and
sending, by the geo-fencing system based on a determination that the UE has entered or exited the geo-fence, a geo-fence alert to the NEF or SCEF for forwarding to a geo-fencing enabled application.

2. The method of claim 1, wherein the geo-fence comprises a UE identifier (ID) associated with the UE, geographic coordinates defining the geographic area of the geo-fence, and an application ID associated with the geo-fencing enabled application.

3. The method of claim 1, wherein, if the UE has been determined to enter the geo-fence, sending the alert comprises sending a geo-fence entry alert to the NEF or SCEF, and
wherein, if the UE has been determined to exit the geo-fence, sending the alert comprises sending a geo-fence exit alert to the NEF or SCEF.

4. The method of claim 1, further comprising:
receiving, by the geo-fencing system, a geo-fencing subscription request from the geo-fencing enabled application via the NEF or SCEF, wherein the geo-fencing subscription request identifies geographic coordinates associated with the geo-fence and identifies the geo-fencing enabled application that originated the subscription request for the UE.

5. The method of claim 4, further comprising:
translating, by the geo-fencing system, the identified geographic coordinates into corresponding RAN identifiers (IDs) associated with a RAN of the mobile network, wherein the RAN IDs comprise at least one cell ID, at least one cell sector ID, at least one eNB ID, at least one gNB ID, or at least one tracking area ID (TAI) within the RAN of the mobile network that define a geographic area of the geo-fence.

6. The method of claim 5, wherein the translating the identified geographic coordinates into corresponding RAN IDs comprises:
identifying, using RAN topology mapping data, at least one of cells, cell sectors, eNBs, gNBs, or tracking areas that are contained within the identified geographic coordinates; and
determining, using the RAN topology mapping data, at least one of cell IDs, cell sector IDs, eNB IDs, gNB IDs, or tracking area IDs associated with the identified at least one of the cells, cell sectors, eNBs, gNBs, or tracking areas that are contained within the identified geographic coordinates.

7. The method of claim 1, wherein the MONTE location report originates from an Access and Mobility Function (AMF) or a Mobility Management Entity (MME) in the mobile network.

8. A geo-fencing system, comprising:
a processing unit configured to store a geo-fence associated with a geographic location of a user equipment device (UE); and
a communication interface configured to receive, from a Network Exposure Function (NEF) or Service Capability Exposure Function (SCEF) in a mobile network, a monitoring event (MONTE) location report associated with a current location of the UE within the mobile network,
wherein the processing unit is further configured to:
extract a Radio Access Network (RAN) location from the MONTE location report, wherein the RAN location identifies a cell, cell sector, eNodeB (eNB), gNodeB (gNB), or tracking area (TA) associated with the current location of the UE,
determine, based on a comparison of the identified cell, cell sector, eNB, gNB, or TA with the stored geo-fence, whether the UE has entered or exited the geo-fence, and
send, based on a determination that the UE has entered or exited the geo-fence, a geo-fence alert to the NEF or SCEF for forwarding to a geo-fencing enabled application.

9. The geo-fencing system of claim 8, wherein the geo-fence comprises a UE identifier (ID) associated with the UE, geographic coordinates defining the geographic area of the geo-fence, and an application ID associated with the geo-fencing enabled application.

10. The geo-fencing system of claim 8, wherein, if the UE has been determined to enter the geo-fence, sending the alert comprises sending a geo-fence entry alert to the NEF or SCEF, and
wherein, if the UE has been determined to exit the geo-fence, sending the alert comprises sending a geo-fence exit alert to the NEF or SCEF.

11. The geo-fencing system of claim 8, wherein the communication interface is further configured to:
receive a geo-fencing subscription request from the geo-fencing enabled application via the NEF or SCEF, wherein the geo-fencing subscription request identifies geographic coordinates associated with the geo-fence and identifies the geo-fencing enabled application that originated the subscription request for the UE.

12. The geo-fencing system of claim 11, wherein the processing unit is further configured to:
translate the identified geographic coordinates into corresponding RAN identifiers (IDs) associated with a RAN of the mobile network, wherein the RAN IDs comprise at least one cell ID, at least one cell sector ID, at least one eNB ID, at least one gNB ID, or at least one tracking area ID (TAI) within the RAN of the mobile network that define a geographic area of the geo-fence.

13. The geo-fencing system of claim 12, wherein, when translating the identified geographic coordinates into corresponding RAN IDs, the processing unit is further configured to:
identifying, using RAN topology mapping data, at least one of cells, cell sectors, eNBs, gNBs, or tracking areas that are contained within the identified geographic coordinates; and
determining, using the RAN topology mapping data, at least one of cell IDs, cell sector IDs, eNB IDs, gNB IDs, or tracking area IDs associated with the identified at least one of the cells, cell sectors, eNBs, gNBs, or tracking areas that are contained within the identified geographic coordinates.

14. The geo-fencing system of claim 8, wherein the MONTE location report originates from an Access and Mobility Function (AMF) or a Mobility Management Entity (MME) in the mobile network.

15. A non-transitory storage medium storing instructions executable by a network device, wherein the instructions comprise instructions to cause the network device to:
store a geo-fence associated with a geographic location of a user equipment device (UE);
receive, from a Network Exposure Function (NEF) or Service Capability Exposure Function (SCEF) in a mobile network, a monitoring event (MONTE) location report associated with a current location of the UE within the mobile network;
extract a Radio Access Network (RAN) location from the MONTE location report, wherein the RAN location identifies a cell, cell sector, eNodeB (eNB), gNodeB (gNB), or tracking area (TA) associated with the current location of the UE;
determine, based on a comparison of the identified cell, cell sector, eNB, gNB, or TA with the stored geo-fence, whether the UE has entered or exited the geo-fence; and
send, based on a determination that the UE has entered or exited the geo-fence, a geo-fence alert to the NEF or SCEF for forwarding to a geo-fencing enabled application.

16. The non-transitory storage medium of claim 15, wherein the geo-fence comprises a UE identifier (ID) associated with the UE, geographic coordinates defining the geographic area of the geo-fence, and an application ID associated with the geo-fencing enabled application.

17. The non-transitory storage medium of claim 15, wherein, if the UE has been determined to enter the geo-fence, sending the alert comprises sending a geo-fence entry alert to the NEF or SCEF, and
wherein, if the UE has been determined to exit the geo-fence, sending the alert comprises sending a geo-fence exit alert to the NEF or SCEF.

18. The non-transitory storage medium of claim 15, wherein the instructions further comprise instructions to cause the network device to:
receive a geo-fencing subscription request from the geo-fencing enabled application via the NEF or SCEF, wherein the geo-fencing subscription request identifies geographic coordinates associated with the geo-fence and identifies the geo-fencing enabled application that originated the subscription request for the UE.

19. The non-transitory storage medium of claim 18, wherein the instructions further comprise instructions to cause the network device to:
translate the identified geographic coordinates into corresponding RAN identifiers (IDs) associated with a RAN of the mobile network, wherein the RAN IDs comprise at least one cell ID, at least one cell sector ID, at least one eNB ID, at least one gNB ID, or at least one tracking area ID (TAI) within the RAN of the mobile network that define a geographic area of the geo-fence.

20. The non-transitory storage medium of claim 19, wherein the instructions to cause the network device to translate the identified geographic coordinates into corresponding RAN IDs further comprises instructions to cause the network device to:
identify, using RAN topology mapping data, at least one of cells, cell sectors, eNBs, gNBs, or tracking areas that are contained within the identified geographic coordinates; and
determine, using the RAN topology mapping data, at least one of cell IDs, cell sector IDs, eNB IDs, gNB IDs, or tracking area IDs associated with the identified at least one of the cells, cell sectors, eNBs, gNBs, or tracking areas that are contained within the identified geographic coordinates.
